(19) United States
(12) Patent Application Publication
(10) Pub. No.: US 2007/0025342 A1
(43) Pub. Date: Feb. 1, 2007

(54) Protocol optimization for wireless networks

(75) Inventor: Hitoshi Obata, Edogawa-ku (JP)

Correspondence Address: CROWELL & MORING LLP;INTELLECTUAL PROPERTY GROUP, P.O. BOX 14300, WASHINGTON, DC, 20044-4300, US

(73) Assignee: Gemini Mobile Technology, Inc., San Mateo, CA (US)

(21) Appl. No.: 11/474,826

(22) Filed: Jun. 26, 2006

Related U.S. Application Data
(63) Continuation-in-part of application No. 11/182,960, filed on Jul. 14, 2005.

(51) Int. Cl. H04L 12/66

(52) U.S. Cl. 370/352; 370/349

(57) ABSTRACT

A system for improving the performance of on-demand mobile communications services includes a wireless network having a plurality of mobile devices and an application server. A relay node receives data from a first mobile device, the data having a destination address associated with the application server. The relay node is adapted to detect a service flag in the received data and route the received data to a second mobile device in accordance with stored routing rules. The received data may be transmitted using the UDP protocol, including error correction code for important data to guarantee packet delivery. A client device may be further adapted to track the duration of idle communications periods during operation of a client application, and transmit a dummy packet to the gaming server when the duration exceed a predetermined threshold to prevent the relinquishment of allocated system resources.

### FIELD OF THE INVENTION

The present invention relates generally to wireless communications systems, and more particularly to systems and methods for optimizing a wireless network for on-demand communications.

### BACKGROUND OF THE INVENTION

Online gaming systems allow remote users, connected to a communications network such as the Internet, to play computer games against each other. Users typically connect to an online gaming server from a client device, such as a personal computer. The client device processes the graphics and sounds for the game and provides the player with the interactive gaming experience. The speed and responsiveness of an online game is typically limited by the communication latency between the client devices and the gaming server. Each client device periodically transmits data messages to the game server regarding the respective player's movements and actions in the game. The gaming server tracks each player through the received data and transmits the data to the other client devices to synchronize the game play.

Wireless environments are typically associated with higher communications latencies than fixed networks that further restrict the online gaming experience. For example, most wireless communications systems were designed and built to provide mobile devices with cost-effective telephone services. The high latencies acceptable in conventional telephone services are not acceptable for applications that require on-demand communications, such as online gaming. In addition, mobile devices are further restricted by less processing power and display capabilities than personal computers.

Wireless communications latencies also restrict other on-demand communications applications such as Push-to-Talk communications. Thus, there is a need for an improved system and method for operating a wireless network to facilitate online gaming and other on-demand services.

### SUMMARY OF THE INVENTION

The present invention is directed to systems and methods for improving the performance of on-demand mobile communications services. In one embodiment, a wireless network includes a plurality of mobile devices, a relay node and an application server. A relay node receives data from a first mobile device, the data having a destination address associated with the application server. The relay node is adapted to detect a service flag in the received data and route the received data to a second mobile device in accordance with stored routing rules. The received data may be transmitted using the User Datagram Protocol (UDP), including an error correction code for important data to guarantee packet delivery. A client device may be further adapted to track the duration of idle communications periods during operation of a client application, and to transmit a dummy packet to the gaming server when the duration exceeds a predetermined threshold to prevent the relinquishment of allocated system resources.

### BRIEF DESCRIPTION OF THE DRAWINGS

FIG. 1 illustrates a mobile network in accordance with an embodiment of the present invention;

FIG. 2 illustrates an embodiment of a data flow of the mobile network of FIG. 1;

FIG. 3 illustrates a mobile network in accordance with an embodiment of the present invention;

FIG. 4 illustrates a mobile device in accordance with an embodiment of the present invention;

FIG. 5 illustrates an application server in accordance with an embodiment of the present invention;

FIGS. 6a-b illustrate a relay node and routing table in accordance with an embodiment of the present invention;

FIG. 7 is a flow diagram illustrating an embodiment of an operation of the relay node of FIG. 6a;

FIG. 8 is an embodiment of relay logic for receiving UDP packets from a mobile device;

FIG. 9 is an embodiment of relay logic for receiving UDP packets from an application server;

FIG. 10 is a flow diagram illustrating a billing method in accordance with an embodiment of the present invention;

FIG. 11 is wireless network in accordance with an embodiment of the present invention;

FIG. 12 is a flow diagram illustrating an embodiment of an operation of the monitoring application of FIG. 11; and

FIG. 13 is a flow diagram illustrating billing logic in accordance with an embodiment of the present invention.

### DETAILED DESCRIPTION

The present invention is directed to systems and methods for improving the performance of on-demand mobile communications services.

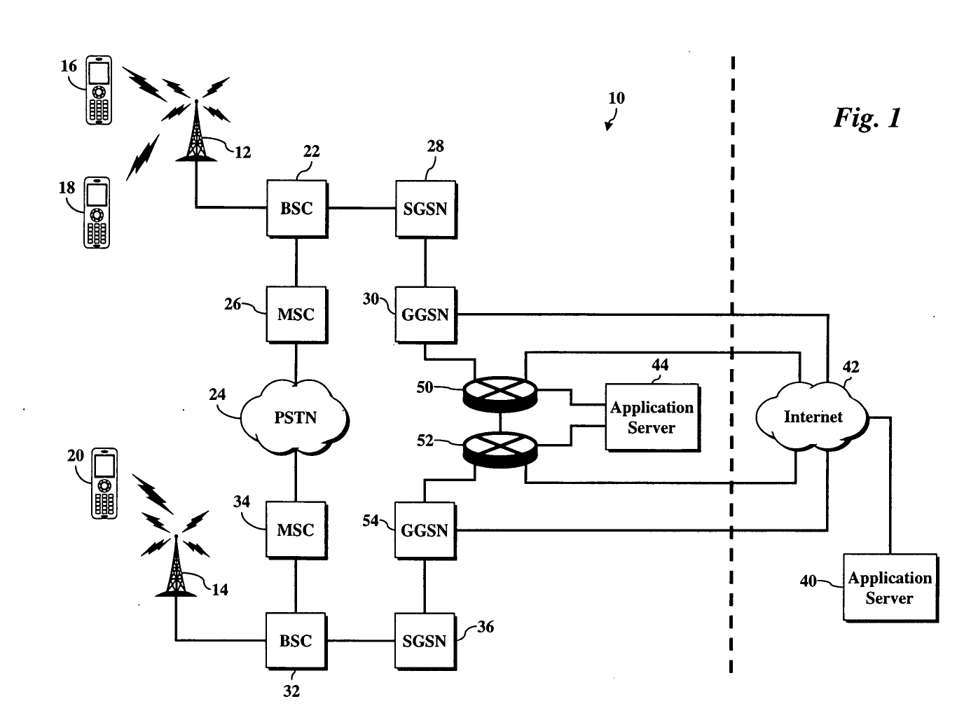

A first embodiment of the present invention will be described with reference to FIG. 1. A mobile network 10 includes a plurality of base stations 12 and 14 providing wireless communications services to a plurality of mobile devices 16 and 18, and 20, respectively. The mobile network 10 is a Global System for Mobile Communications (GSM) network, but it will be appreciated that the present invention will support other wireless communications systems and protocols such as TDMA, CDMA and WCDMA networks. The mobile devices 16, 18 and 20 may be any devices that are adapted to communicate with the base stations 12 and 14 such as mobile phones, personal digital assistants (PDAs) or handheld computers.

The base station 12 is connected to a base station controller 22 which routes interconnect communications to a Public Switched Telephone Network (PSTN) 24 through a Mobile Switching Center (MSC) 26. Packet data communications are routed from the base station 12 to a Serving GPRS Support Node (SGSN) 28 which connects the mobile network 10 to a Gateway GPRS Support Node (GGSN) 30. The base station 14 is connected to a base station controller 32 which routes interconnect communications to PSTN 24 through an MSC 34, and packet data communications to an SGSN 36 which is connected to a GGSN 54.

The mobile devices 16, 18 and 20 are adapted for online game play through an application server. In a conventional configuration, for example, mobile device 16 may access an application server 40 through the Internet 42 to download a client version of a game (such as a Java application), set up a game environment and engage in online game play with one or more of the mobile devices 18 and 20, or other client devices. During game play, each of the mobile devices communicates with the application server 40 through the Internet 42 to share game status information such as character position and other data to synchronize game play. The application server 40 processes the received information and transmits game synchronization information to each of the participating mobile devices.

To facilitate more responsive multiplayer game play and faster data transfer, the mobile network 10 of the present embodiment includes at least one relay node 50 and an application server 44. The relay node 50 is a router connected to the GGSN 30 that provides a data communications link between the mobile devices 16 and 18 and the application server 44, and facilitates peer-to-peer routing between the mobile devices 16, 18 and 20. The relay node 50 may also be adapted to route data communications between a mobile device and another network, such as between mobile device 16 and the Internet 42. The application server 44 may be part of the mobile network 10 (as illustrated), or may be an external system.

In operation, the relay node 50 screens gaming data packets from the SGSN 28 and facilitates peer-to-peer routing of gaming information that does not require processing by the application server 44. For example, the relay node 50 may receive data packets from mobile device 16 and, bypassing the application server 44, route the data packets to mobile device 18, to a second relay router 52 for forwarding to the mobile device 20, or to a plurality of destinations as dictated by the stored routing rules. A copy of the data packets may also be forwarded to the application server 44 as required. If processing by the application server 44 is required, the relay router 50 transmits the data packets to the application server 44. The application server 44 processes the received data and transmits updated gaming data to mobile devices 16, 18 and 20 through the relay nodes 50 and 52.

It will be appreciated by those skilled in the art that the relay node 50 may connect to any application server providing services to the mobile devices including game servers and Push-to-Talk (PTT) servers. In a PTT application, after the PTT session is set up between two mobile devices, communications can proceed peer to peer through the relay nodes, bypassing the application server and providing more instantaneous communication.

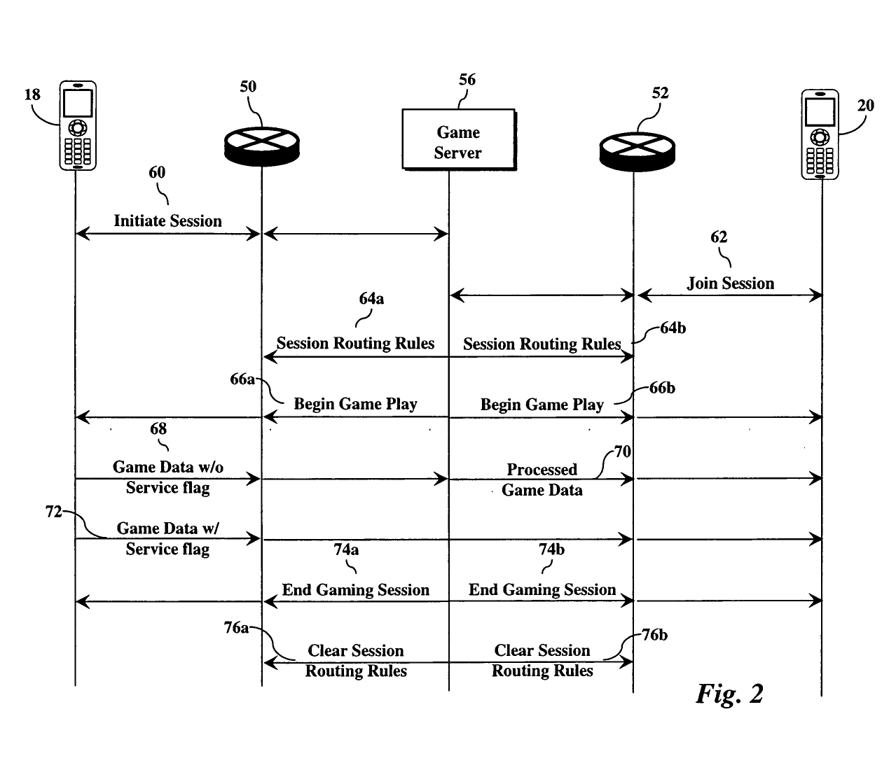

Referring to FIG. 2, an embodiment of an operation of a gaming application will be described. In this embodiment, mobile device 18 and mobile device 20 participate in an online game through a game server 56. The user of mobile device 18 accesses the game server 56 through a gaming application on the mobile device 18 and initiates a gaming session. The communication 60 between the mobile device 18 and game server 56 is routed through the relay node 50. The mobile device 20 also accesses the game server 56 through a gaming application on the mobile device 20 and joins in the gaming session. The communication 62 between the mobile device 20 and the game server 56 is routed through the relay node 52.

The game server 56 passes session routing rules 64a and 64b to the relay nodes 50 and 52, respectively, that are servicing the mobile devices. Systems and protocols for updating stored routing rules in a router are known in the art and may be used in accordance with various embodiments of the present invention. Game play begins after gaming data 66a and 66b is routed to each mobile device. During game play, the mobile devices will need to provide synchronization data to the each other and the gaming server. Game data 68 is transmitted from the mobile device 18 to the game server 56. The game data 68 is received at the relay node 50, which determines that a service flag has not been set, and routes the game data to the game server 56 in accordance session routing rules 64a. The game server 56 processes the data as needed and forwards the processed data 70 to the mobile device 20. The processed data is routed to relay node 52, which forwards the message to the mobile device 20.

For messages that do not require processing by the game server 56, the mobile device 18 sets a service flag in the header of the game data 72. When the mobile device 18 transmits the game data 72 to the game server 56, the relay node 50 applies the routing rules 64a to bypass the gaming server 56. The appropriate routing rules may be identified based on a session id, a source id, a destination id and/or other identifiers. In one embodiment the relay node 50 identifies the mobile device 18 as the source, the game server 56 as the destination and the service flag setting, and applies the rules 64a to route the game data 72 to the mobile device 20 through the relay node 52. After the session terminates (see communications 74a and 74b) the game server 56 removes the session rules 64a and 64b from the relay nodes 50 and 52 in communications 76a and 76b.

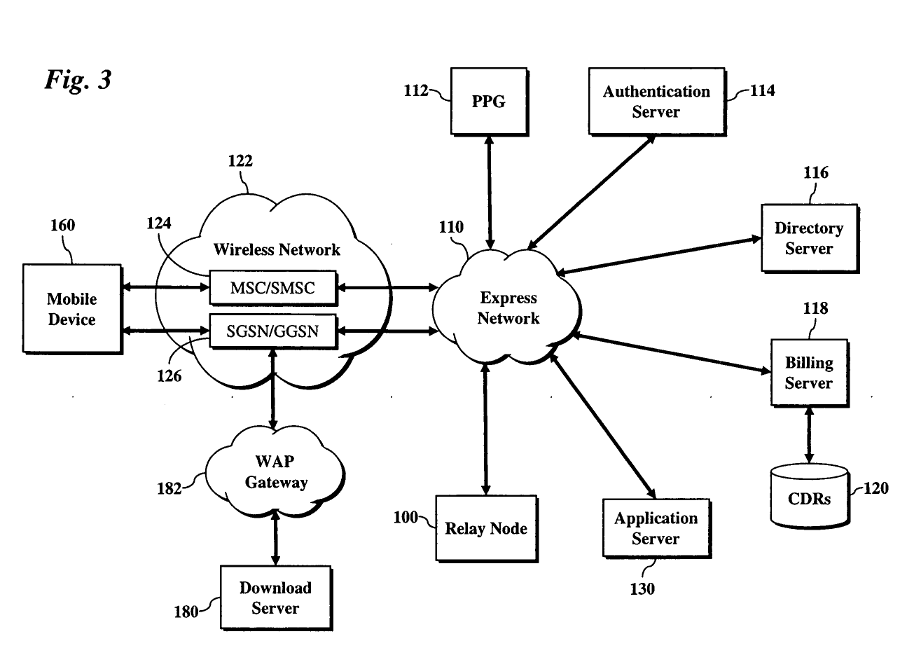

Referring to FIG. 3 illustrates an embodiment of a relay node in an express network. A relay node 100 is an entity in an express network 110 that further includes a Push Proxy Gateway (PPG) 112, an authentication server 114, a directory server 116, a billing server 118, and at least one application server 130. The express network 110 is connected to a wireless network 122 that provides wireless communications services to at least one mobile device 160 via MSC/SMSC 124 and SGSN/GGSN 126.

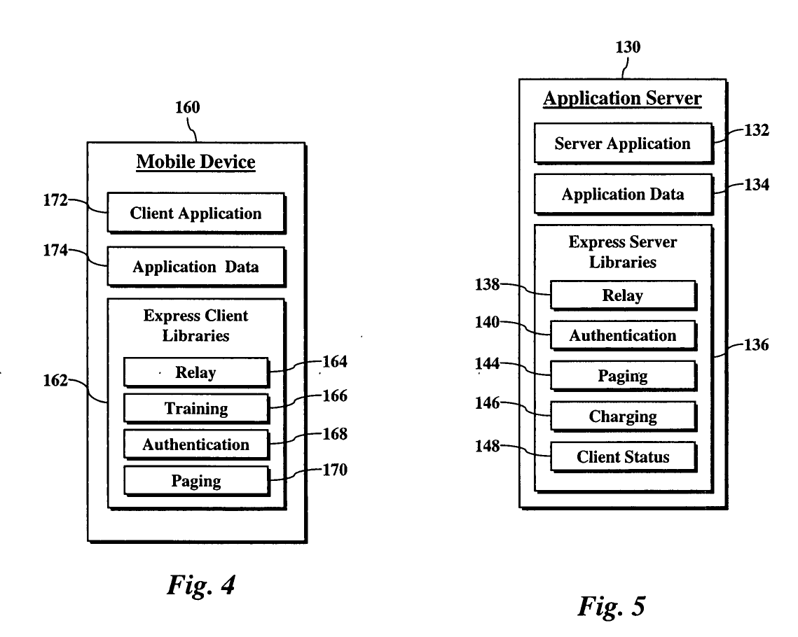

With reference to FIG. 4, the mobile device 160 includes a memory storing express client libraries 162 enabling communications between the mobile device 160 and the express network 110, including a relay library 164 that supports UDP packet communication with the application server 130 through the relay node 100. In one embodiment, the mobile device 160 also includes a training library 166, an authentication library 168 and a paging library 170. The training library 166 includes logic for measuring the performance of the communications between the mobile device 160 and the application server 130 to determine an appropriate mode for the relay library 164 to apply to communications. The authentication library 168 includes authentication logic for data communications within the express network 110, including logic for use of relay keys and tokens as described herein. The paging library 170 includes logic for facilitating communications between mobile devices and receiving paging requests from the PPG 112. For example, the mobile device 160 may receive a paging request initiated by another mobile device to join an online game, and the paging library 170 may be adapted to launch the associated game application upon receiving the request.

The mobile device 160 also stores a client application 172 and associated application data 174. The client application 172 may be included in the device firmware, downloaded from the application server 130, downloaded from a download server 180 through a WAP gateway 182, or acquired by other methods. The client application 172 includes logic to transmit data messages, including application data, to the application server 130 using the UDP protocol as discussed herein. The client application 172 may also use other protocols for communications within the express network 110, including HTTP/TCP.

Referring to FIG. 5, the application server 130 includes a memory storing a server application 132, application data 134 and express server libraries 136. In one embodiment, communications with the application server 130 are facilitated using the express server libraries 136, which include a relay library 138, an authentication library 140, a paging library 142, a charging library 144 and a client status library 146. The relay library 138 includes logic to facilitate communications through the relay node 100, such as support for UDP packet communications with the mobile device 160. The charging library 144 defines the billing methodology for use of an online application, and facilitates communication with the billing server 118. The authentication library 140 facilitates data authentication between the application server 130, the mobile device 160 and the relay node 100. The paging library 142 includes logic for communicating with the PPG 112 for contacting mobile users who are waiting for features or have been requested to join in an application session. The client status library 146 includes logic for maintaining information on the status of mobile devices that are logged into the application server 130.

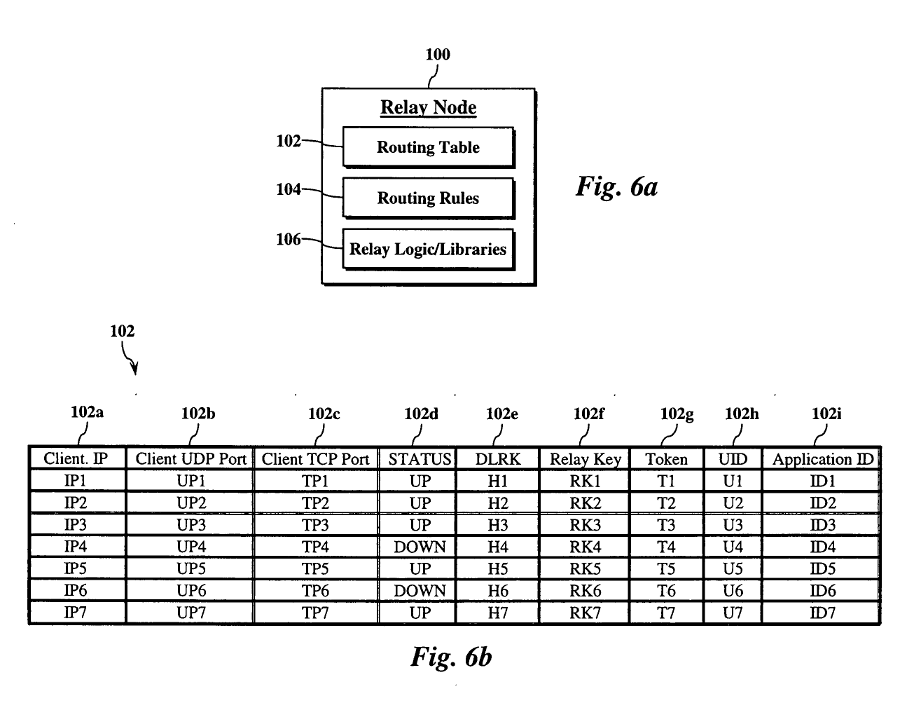

Referring to FIG. 6a, the relay node 100 includes a routing table 102, routing rules 10.4 and relay logic and express libraries 106. The relay logic 106 is configured to route application data packets to other relay nodes in the express network 110, to the application server 130 or to the Internet or other IP network. Routing may be based on protocol, such as TCP/IP or UDP, may be based on destination IP address of the application server 130, or other routing techniques.

The routing table 102 identifies other network elements, including a relay context of the mobile device 160. An exemplary routing table 102 is illustrated in FIG. 6b. The routing table 102 includes a mobile client IP address 102a, a client UDP port number 102b for use by the client application, a client TCP port 102c for use by the client application, a client status 102d showing whether the client is active (UP) or has timed out due to inactivity (DOWN), a downlink relay key (DLRK) 102e, a relay key 102f, a token 102g, a user identifier 102h and an application ID 102i. The relay key 102f is a key allocated to each client game application and used to verify UDP data. In one embodiment, the DLRK 102e is a hash of the relay key 102f and a time factor, which is used by the relay node for uplink of client data to the content server. The token 102g includes session key information allocated to each client game application for use in verifying TCP data.

Referring back to FIGS. 3 and 6a, the routing rules 104 include rules configurable by the application server 130, including rules directing the relay node 100 to forward data packets from mobile device 160 to another mobile device. In one embodiment, the relay node 100 produces call detail records (CDRs) to facilitate billing for use of the relay node 100 and/or the application server 130. The CDRs are provided to a database 120 for use by the billing server 118 in billing the mobile user.

In conventional gaming applications, data is transmitted between the gaming server and client using Transmission Control Protocol (TCP). Because TCP guarantees that all data is received, lost packets or delayed packets can slow down the data transmission rate and impede game play.

In the present embodiment, an express relay protocol is defined between the mobile device 160 and the application server 130 using UDP. The use of UDP facilitates a low latency data communication environment for online game applications and other on-demand applications. UDP is commonly used for real time communications in stable communications environments such as streaming media on a fixed network. In streaming media applications, lost data packets are not critical and may be discarded. Wireless environments, however, are not typically as stable as fixed networks, and certain data in non-streaming applications may be critical and cannot be lost. In accordance with the present embodiment, the UDP protocol is modified for use with wireless on-demand applications to include a service flag, error correction and authentication features.

In one embodiment, the client and server relay libraries 164 and 138 (FIGS. 4 & 5), respectively, support three types of information transfer between the mobile device and the application server: regular information, important information and TCP. Regular information that requires low latency is sent via UDP. This type of information is not critical and may be repeated often in the data stream, so some lost data packets may be tolerated. For example, information regarding a game player's position, movements and actions are transmitted throughout game play, and a small number of dropped packets will not have a major impact on the overall gaming experience. Important information may be sent via UDP using one or more sub-modes including data acceleration when the lowest latency is required, packet redundancy, or error correction, such as data interleaving. Using interleaving causes some additional latency in the data rate as compared to regular information transfer but helps prevent lost data due to signal interruptions. Other data, including data sent outside of a gaming environment, is transmitted using TCP. In one embodiment, separate relay nodes are established for handling TCP and UDP data transfer modes, respectively.

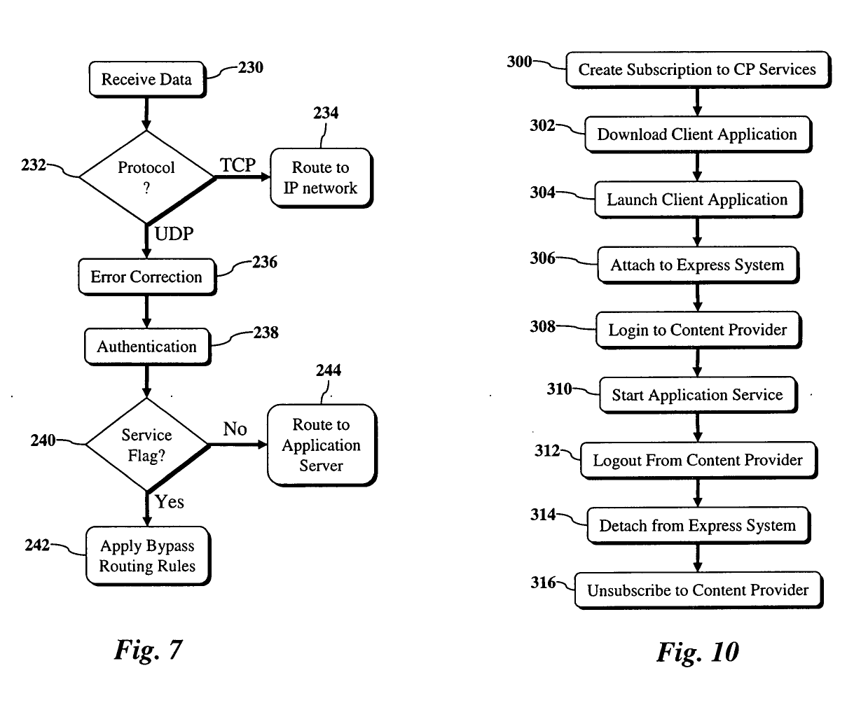

In the present embodiment, the relay node 100 supports secure transmission of UDP packets in a low latency communication environment between the mobile device 160 and the application server 130. The relay logic 106 (FIG. 6a) includes logic for handling and routing incoming data packets. An embodiment of the relay logic 106 is illustrated in FIG. 7. In step 230, the relay node receives incoming data. In step 232 the protocol is determined and the data is forwarded to an IP network in step 234 if TCP data was received. If the TCP data is directed to the application server, the relay node checks the message header (e.g., HTTP message header) for a token of the transmission session and transmits the data packet to the application server if the token is valid. In one embodiment, the token is provided to the client as a part of the relay context when the client attaches to the express network, and the client may use the same token until it detaches from the express network. The validity of the token is determined by the relay node by comparing the received token to the stored token associated with a user ID (UID) and Application ID pair. The application server receives the request and may transmit an HTTP response back to the mobile device through the relay node.

If UDP data was received by the relay node, then in step 236 the relay node performs error correction if used on the incoming data. In step 238, the relay node authenticates the incoming data using a relay key in embodiments where authentication is required. In step 240 the relay node detects the service flag and, if it is set, applies the routing rules in step 242 to forward the data to another mobile device, bypassing the application server. If the service flag is not set, the relay node forwards the data to the application server in step 244.

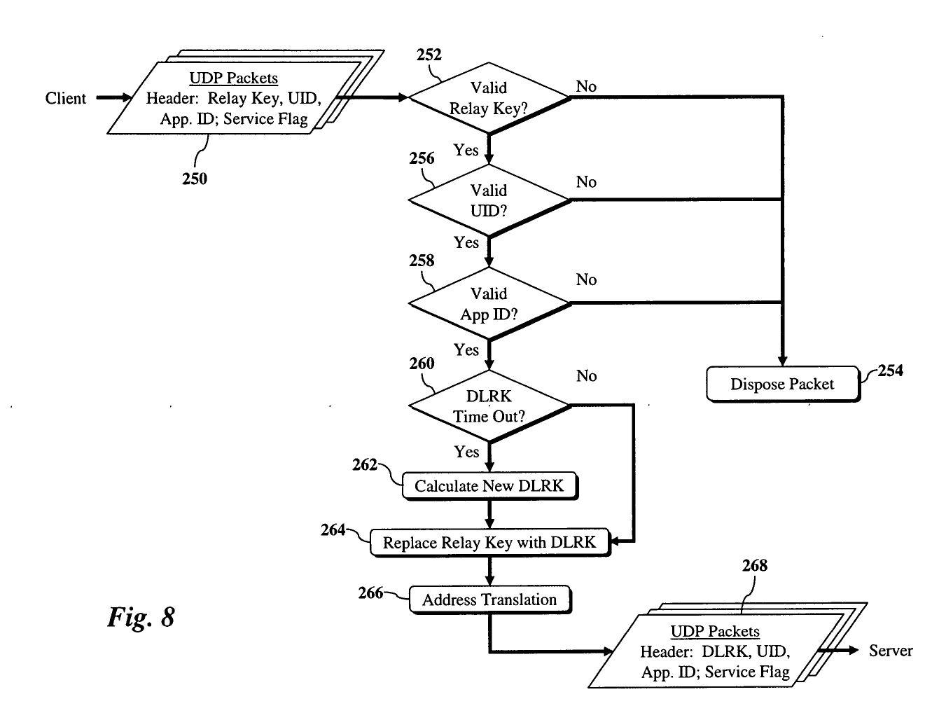

An embodiment of relay logic 106 for receiving UDP packets from the mobile device 160 is illustrated in FIG. 8. The client mobile device transmits UDP packets 250 to the application server through the relay router. Each UDP packet 250 includes header data including a relay key, a user ID (UID), an application ID and a service flag. The relay router receives the data 250, and tests the relay key in step 252 against stored data in the routing table. If the relay key is valid, then the router tests the UID and application ID in steps 256 and 258, respectively. If any of the relay key, UID or application ID are invalid, then the data packet is disposed in step 254. In step 260, the relay router tests the downlink relay key (DLRK) from the associated relay context and if expired, calculates a new downlink relay key in step 262. In one embodiment, the new DLRK is calculated using a hash function of the relay key and a time factor. In step 264, the relay key in the header of the data received from the client is replaced with the downlink relay key. Address translation for the express network is performed in step 266. In one embodiment, the relay node maintains an uplink activity supervision timer, which is reset when UDP data is forwarded from the client to the application server. If the activity timer expires due to inactivity, then the relay node changes the client STATUS in the relay context from UP to DOWN. At this step, the activity timer is reset to start a new period of inactivity. Next, the data 268 is forwarded to the application server, or directly to another mobile device if the service flag is on.

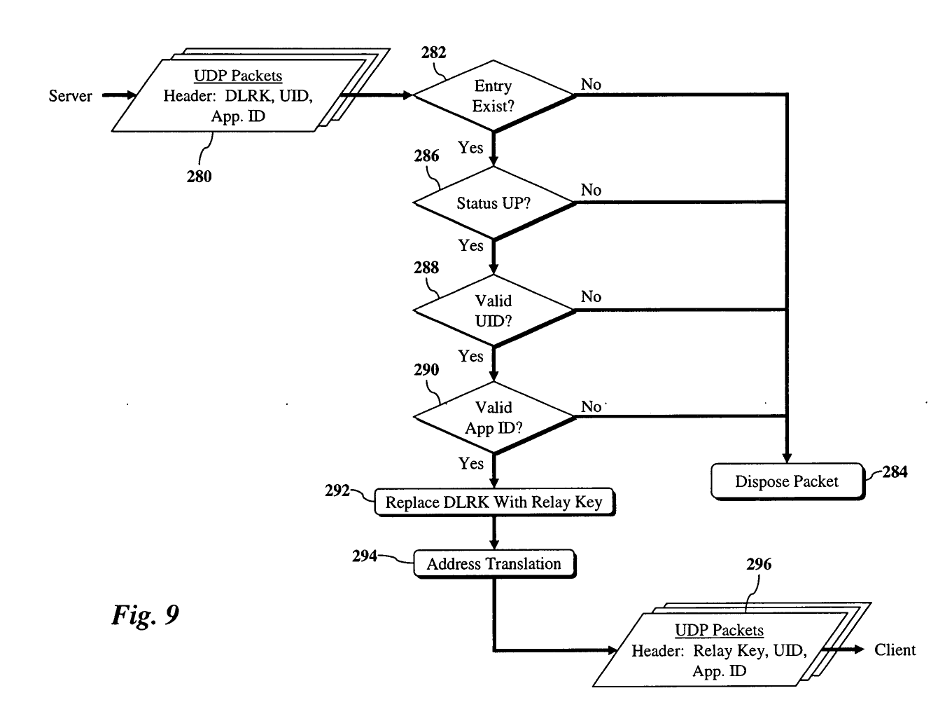

An embodiment of relay logic 106 for receiving UDP packets from the application server 130 is illustrated in FIG. 9. The application server transmits UDP packets 280 to the mobile device through the relay router. Each UDP packet 280 includes header data including a DLRK, a UID and an application ID. The relay router receives the data 280, and queries the routing table for a corresponding entry base on the UID/application ID pair, in step 282. If an entry is found, the status, UID, and application ID are then tested against stored values for the relay context in steps 286, 288 and 290, respectively. If any of the tests in steps 282, 286, 288 or 290 fail, then the data packet is disposed in step 284. For example, if the STATUS is DOWN due to no uplink activity from the mobile client during a predetermined period of time, then the UDP data will not be forwarded to the mobile client. If the received data is valid, then the DLRK is replaced with the relay key in step 292 and, after address translation in step 294, is forwarded to the client in step 296.

In one embodiment, the mobile user establishes a subscription with a content provider in order to access the content provider through the relay node. An embodiment, of a subscription service in an express network is illustrated in FIG. 10. In step 300, the mobile client creates a subscription with a content provider. The subscription may be established through a carrier download server, by accessing the content provider through the Internet, or through other methods as known in the art. The mobile client downloads an associated client application in step 302. In one embodiment, the client application is downloaded using the wireless carrier's existing content download procedures or directly from the content server.

In step 304 the client application is launched on the mobile device. When the client application is launched for the first time, a client registration request (including UID and an application ID) is transmitted to the authentication server. The authentication server creates an entry for the mobile client in the directory server, generates billing information, and responds back to the mobile client with an associated express network password. The communications between mobile device and the authentication server may use HTTP, TCP/IP or other data protocol.

In step 306, the mobile client connects to the express network. In one embodiment, the client transmits an attach request including the mobile client's UID, the application ID and the express network password to the authentication server. The authentication server verifies the received data through the directory server. If the request is accepted, the authentication server transmits a relay context setup request to the relay node, including a transaction ID identifying the setup request, the UID, application ID and Client IP address received from the client, and an associated relay key and token provided by the authentication server. The relay node creates an entry in the relay table and stores the received information, starts generating charging information and responds back to the authentication server with the transaction ID and result code. After establishing the relay context with the relay node, the authentication server responds back to the mobile client with a verification message that the mobile device is attached to the express network. The verification message includes the relay key, token, the relay node IP address and other relay context information.

After attachment of the mobile client to the express network, the client logs into the content provider in step 308. During login, there is typically no need to be in a low latency state, and the login data may be transmitted using HTTP/TCP. In one embodiment, the mobile client transmits a login request to the content server via the relay node, including UID, application ID and the associated token. The relay node processes the data as application data and checks the token against the token stored in the routing table for the relay context. If the token is valid, the login request is forwarded to the content server. The content server verifies the mobile client through the authentication server by transmitting a UID, application ID and token to the authentication server. Authentication is accomplished by comparing the received token to the stored token value for the relay context. The authentication server generates charging information for the client during login. The content server records the last token used per client and transmits a response back to the mobile device via the relay node, which verifies the token and forwards the response to the mobile device.

In step 310, the application starts and data transfer between the mobile client, the content server, and other mobile clients is facilitated through the relay node. Application data may be transmitted only after the client attaches to the express network and is logged in to the content server. Data packet forwarding is facilitated via the relay node, which creates billing information for data transfer events. Billing information may include transfer mode (UDP or TCP), destination, start time, end time, data volume, usage of acceleration, and other data transfer information. The content server may create billing information for various application events such as paging requests and billing based on application data.

In step 312, the mobile client logs out from the content provider. The client may log out from the express network by transmitting a logout request to the content server including UID, application ID and token. The relay node verifies the token and forwards the logout request to the content server. The content server verifies the token, responds back to the mobile client regarding the successful logout, and notifies the authentication server that the user has logged out.

The mobile client disconnects from the express network in step 314. The mobile client may detach from the express network by transmitting a detach message to the authentication server including the UID, application ID and password. The authentication server will transmit a client detach response to the mobile device, generate charging information for detaching the mobile client, and transmit a relay context delete request to the relay node. The relay node deletes the relay context, stops generating charging information for the client, and responds back to the authentication server.

Detachment may also be initiated by the relay node after a timeout period or by notification from the application server. When the mobile client is detached, the relay context is deleted from the relay node and data transmission between the mobile client and the relay node will be prohibited. The authentication server will then terminate the billing information for the attachment session. The user may unsubscribe from the content provider in step 316, if desired. The content provider reports the UID and application ID to the authentication server which deregisters the client application by modifying or removing the data entry associated with the UID/Application ID pair.

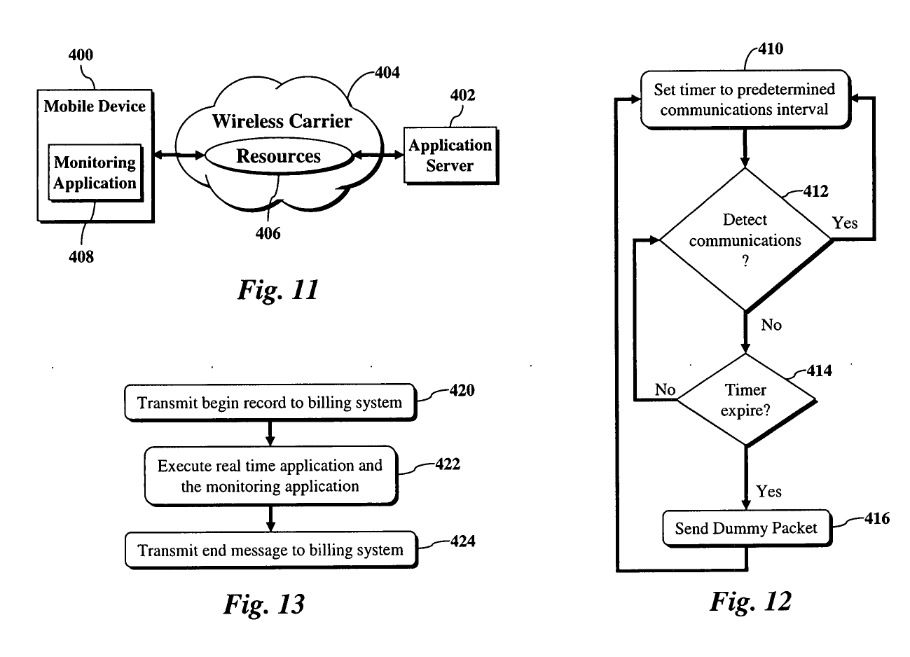

Another embodiment of the present invention will now be described with reference to FIGS. 11 through 13. Referring to FIG. 11, when a mobile device 400 establishes communications with an application server 402 through a wireless carrier 404, the wireless carrier 404 allocates network resources 406 for the communication, establishing a communications path. The mobile device 400 relinquishes the allocated resources 406 when the communications session terminates or after a certain period of inactivity. After resources are relinquished, the next communication between the mobile device 400 and the application server 402 will be delayed while the resources 406 are reallocated. In many networks, the delay may be between 3-6 seconds for the retrieval of the new resources and a return to an active communications state. A 3-6 second delay is unacceptable for many on-demand communications applications, such as online gaming and push-to-talk communications.

In accordance with the present embodiment, the mobile device 400 includes a software monitoring application 408 for measuring the idle time between communications. If the idle time exceeds a predetermined threshold while the mobile device 400 is engaged in online gaming, PTT communications or other realtime application, then the mobile device 400 will transmit a dummy packet to the application server 402. Passing the dummy packet through the wireless carrier 404 will reserve the resources 406 and initiate a new idle period. The monitoring application 408 may be part of the system software or libraries of the mobile device 400.

An embodiment of the operation of the monitoring application 408 is illustrated in FIG. 12. In step 410, a timer is set to a predetermined communications interval. The predetermined communications interval may be set at maximum idle period that the network will tolerate before releasing allocated resources. This interval will vary between wireless networks. In certain 3G GPRS networks, it has been found that the network will enter an idle state and release the network resources where there is no data transmission for 70 to 80 seconds. In one embodiment, the mobile device 400 tests the network to determine an appropriate communications interval. The network may be tested by measuring the latency of a first packet transmission, maintaining an idle state for an interval, and then measuring the latency of a second packet transmission. This is repeated with incrementally longer intervals while the latency period remains relatively stable. Eventually, the length of the idle period will cause the network to drop the allocated resources and allocate new resources for the mobile device 400 in order to deliver the dummy packet. This will cause a spike in the latency measurement indicating that the previously tested interval may be appropriate for use in step 410.

In step 412, if the monitoring application 408 detects a wireless communications event on the mobile device, then the timer is reset in step 410. After the timer expires in step 414, a dummy packet is sent in step 416. The timer is then reset in step 410.

Because there are limited resources on a wireless network, the wireless carrier 404 may charge a premium for tying up the resources through the monitoring application 408. Referring to FIG. 13, in step 420 when an application requiring realtime communications is launched with the monitoring application, a billing notification record is transmitted to the wireless carrier's billing system. In step 422, the realtime application is executed while the monitoring application maintains system resources by periodically transmitting dummy packets across the network. When the use of the monitoring application terminates, in step 424 a second billing notification record is transmitted to the billing system to mark the end of the premium realtime service.

Having thus described various embodiments of the present invention, it should be apparent to those skilled in the art that certain advantages of the within described system have been achieved. It should also be appreciated that various modifications, adaptations, and alternative embodiments thereof may be made within the scope and spirit of the present invention.

What is claimed is:

1. In a wireless network including a plurality of mobile devices and a gaming server, a method for online gaming comprising:
receiving data from a first mobile device, the data having a destination address associated with the gaming server;
authenticating the received data;
detecting a service flag in the received data; and
routing the received data to a second mobile device, bypassing the gaming server, in accordance with stored routing rules if the service flag is set.

2. The method of claim 1 wherein the step of routing further comprises routing the received data to a third mobile device.

3. The method of claim 1 wherein the step of routing further comprises routing the received data to a relay node servicing the second mobile device.

4. The method of claim 1 further comprising the step of routing the received data to the gaming server if the service flag is not set.

5. The method of claim 1 wherein the received data has a UDP format.

6. The method of claim 1 further comprising receiving and storing the routing rules from the gaming server.

7. A wireless client for use in a multiplayer online wireless gaming system, the wireless client device comprising:
a client application adapted to generate gaming data during a gaming session;
a relay library including program instructions for causing the client device to:
determine whether the generated gaming data requires processing by the gaming server; and
transmit the gaming data to the gaming server, wherein the gaming data includes a header having a service flag that is set only if the gaming data does not require processing by the gaming server; and
an authentication library including program instructions for causing the client device to associate a relay key with the transmitted gaming data.

8. The client device of claim 7 wherein the transmitted gaming data includes an error correction code.

9. The client device of claim 7 wherein the error correction code includes interleaved data.

10. The client device of claim 7 wherein the relay library further includes program instructions for causing the client device to include the relay key in transmitted gaming data.

11. The client device of claim 7 wherein the relay library further includes a monitoring application including program instructions for causing the client device to:
track the duration of idle communications periods during the operation of the client application; and
transmit a dummy packet to the gaming server when the duration exceeds a predetermined threshold.

12. The client device of claim 11 wherein the monitoring application further includes program instructions for causing the client device to transmit a first billing notification to a billing server when the monitoring application is launched, and to transmit a second billing notification to the billing server when the monitoring application is terminated.

13. In a wireless network including a plurality of mobile devices and an application server connected through a data network, a relay node comprising:
an interface to the data network;
a memory storing routing rules; and
a program memory including program instructions for causing the relay node to:
receive data from the wireless network, the data including a source address of a first mobile device and a destination address of the application server;
authenticate the received data;
detect a service flag in the received data; and
route the received data to a second mobile device in accordance with the stored routing rules if the service flag is set.

14. The relay node of claim 13 wherein the received data is also routed to a third mobile device in accordance with the stored routing rules if the service flag is set.

15. The relay node of claim 13 wherein the received data is routed to a second relay node servicing the second mobile device.

16. The relay node of claim 13 wherein the interface includes functionality for handling UDP data.

17. The relay node of claim 13 wherein the stored routing rules are received from the application server.

18. The relay node of claim 13 wherein the program memory further includes program instructions for causing the relay node to route the received data to the application server if the service flag is not set.

19. The relay node of claim 13 wherein the application server is a gaming server and the received data is gaming data.

20. The relay node of claim 13 wherein the application server is a PTT server and the received data includes PTT communications data.

21. The relay node of claim 13 wherein the program memory further includes program instructions for causing the relay node to generate and store a call detail record for the received data.

22. The relay node of claim 13 wherein the program memory further includes program instructions for causing the relay node to:
detect a relay key in the received data;
authenticate the received data by comparing the relay key against a stored relay key; and
route the received data only if the relay key matches the stored relay key, and discarding the received data if the relay key does not match the stored relay key.
